(19) United States
(12) Patent Application Publication
(10) Pub. No.: US 2014/0280294 A1
(43) Pub. Date: Sep. 18, 2014

(54) CONNECTING USERS IN SEARCH SERVICES BASED ON RECEIVED QUERIES

(71) Applicant: Google Inc., (US)

(72) Inventors: Zoltan Stekkelpak, Sunnyvale, CA (US); Gyula Simonyi, Dublin (IE); Sara Su, San Jose, CA (US); Sean Liu, El Dorado Hills, CA (US)

(73) Assignee: Google, Inc., Mountain View, CA (US)

(21) Appl. No.: 13/800,346

(22) Filed: Mar. 13, 2013

(51) Int. Cl. G06F 17/30

(52) U.S. Cl. CPC G06F 17/30477
USPC 707/769

(57) ABSTRACT

Methods, systems, and apparatus, including computer programs encoded on a computer storage medium, for receiving a search query from a searching user, defining a set of users based on the query, the set of users being a sub-set of a super-set of users and including one or more users that have submitted queries that are determined to correspond to the search query, providing an electronic document comprising instructions that, when executed by a computing device, cause the computing device to display a search results page including search results responsive to the search query and a connection interface, the connection interface displaying at least one indication of users of the set of users, and transmitting the electronic document to a computing device associated with the searching user.

### BACKGROUND

The Internet provides access to a wide variety of resources, such as image files, audio files, video files, and web pages. A search system can identify resources in response to queries submitted by users and provide information about the resources in a manner that is useful to the users. The users then navigate through (e.g., click on) the search results to acquire information of interest to the users.

Users of search systems are often searching for information regarding a specific entity. For example, users may want to learn about a singer that they just heard on the radio. Conventionally, the user would initiate a search for the singer and select from a list of search results determined to be relevant to the singer.

### SUMMARY

This specification relates to presenting data with search results.

Implementations of the present disclosure are generally directed to connecting users based on queries submitted to a search system, and more particularly to displaying, to a searching user that has submitted a search query, information about other searches being contemporaneously performed by other searching users based on the search query. Implementations of the present disclosure further enable the searching user to interact with other users through online discussions.

In general, innovative aspects of the subject matter described in this specification can be embodied in methods that include actions of receiving a search query from a searching user, defining a set of users based on the query, the set of users being a sub-set of a super-set of users and including one or more users that have submitted queries that are determined to correspond to the search query, providing an electronic document comprising instructions that, when executed by a computing device, cause the computing device to display a search results page including search results responsive to the search query and a connection interface, the connection interface displaying at least one indication of users of the set of users, and transmitting the electronic document to a computing device associated with the searching user. Other implementations of this aspect include corresponding systems, apparatus, and computer programs, configured to perform the actions of the methods, encoded on computer storage devices.

These and other implementations can each optionally include one or more of the following features: the connection interface displays a user-selectable invitation to participate in an online discussion; actions further include providing instructions to display a connection interface to the searching user in response to user input to the invitation, the connection interface providing a communication channel for user participation in the online discussion; actions further include assigning the searching user to a discussion group in response to user input to the invitation; assigning the searching user to the discussion group is based on an engagement category associated with the searching user; actions further include, for each user of the superset of users: associating a threshold timeliness with a query submitted by a respective user, comparing a time at which the search query was received to a time at which the query was received to provide a timeliness of the query, and determining that the timeliness is below the threshold timeliness and, in response, including the respective user in the set of users; the threshold timeliness is determined based on an interest interval associated with the searching query; a query that corresponds to the search query includes a query that is at least one of the same as the search query, similar to the search query, is a synonym of the search query, is semantically equivalent to the search query, and that is associated with the same or similar topics as the search query is associated with; and the at least one indication includes at least one of a number of users in the set of users, a location of users in the set of users, and at least one user in the set of users that is also a contact of the searching user in one or more computer-implemented services.

Particular implementations of the subject matter described in this specification can be implemented so as to realize one or more of the following advantages. Implementations of the present disclosure remedy user impression of “utilitarian” or “solitary” search by providing users with real-time feedback on concurrent search activity of other users. In some examples, this benefits various types of users, e.g., beginner, non-expert users, by being exposed to related queries is an effective technique. In this manner, less experienced users, for example, can be educated on search query formulation, ultimately improving exploratory search experience and increasing the overall number of search queries submitted to a subject search service. Implementations of the present disclosure further enable interaction between authenticated users and unauthenticated users, and enable users to participate anonymously, under an assumed persona, or as themselves. Implementations further enable performance-based filtering and/or targeting, where a number of user interaction channels can be extended and/or targeted to user groups in response to user engagement. Implementations further provide a complement to search results where, for example, interaction channels can be provided in response to determining that the user is unsatisfied with displayed search results. For example, communication channels can be prompted after a threshold number of search result clicks on the same search result page, or, when the user stays only for a short time on a target page, and then comes back to the search result page. Accordingly, user interaction with other searching users through a communications channel can supplement search results displayed to the user.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment in which a search system provides search services.

FIG. 2 depicts a screen shot of an example search interface in which a search results page is provided.

FIGS. 3A-3D depict example connection interfaces that can be displayed in search results pages.

FIG. 4 is a flowchart of an example process that can be executed in accordance with implementations of the present disclosure.

Like reference numbers and designations in the various drawings indicate like elements.

### DETAILED DESCRIPTION

FIG. 1 depicts an example environment 100 in which a search system 120 provides search services. The example environment 100 includes a network 102 that connects resources 104, user devices 106, and the search system 120 for communication therebetween. Example resources can include web sites. In some examples, the network 102 includes a local area network (LAN), wide area network (WAN), the Internet, telephone networks, e.g., public switched telephone network (PSTN) and/or cellular network, or any appropriate combination thereof. Although implementations of the present disclosure are discussed in the example context of search queries provided to a search system, it is contemplated that implementations of the present disclosure can be applied in other contexts. Another example context can include command queries, e.g., “book a hotel room in san Francisco,” “play the song wheels on the bus.”

In some examples, a user device 106 is an electronic device that is under control of a user and is capable of requesting and receiving resources 104 over the network 102. In some examples, user devices 106 can include a mobile phone, a smartphone, a personal digital assistant (PDA), a laptop computer, a desktop computer, a tablet, wearable computing devices, smart-appliances, e.g., smart-TV, and any appropriate combinations thereof. As used throughout this document the term mobile computing device (“mobile device”) refers to a user device that is configured to communicate over a mobile communications network. A smartphone, (i.e., a phone that is enabled to communicate over the Internet) is an example of a mobile device. A user device 106 typically includes a user application, e.g., a web browser, to facilitate the sending and receiving of data over the network 102. Implementations of the present disclosure can be provided with other search interfaces including, for example, voice-based input, e.g., voice-controlled assistants, image-based input and/or handwriting-based input.

In some examples, the network 102 can be accessed over a wired and/or a wireless communications link. In some examples, computing devices, e.g., smartphones, can utilize a cellular network to access the network 102. For example, communication can be provided under various modes or protocols. Example protocols can include SMS, EMS or MMS messaging, GSM, TCP, UDP, RTP, VoIP, FDMA, CDMA, TDMA, PDC, WCDMA, CDMA2000, TD-SCDMA and/or GPRS. Such communication may occur, for example, through a radio-frequency transceiver (not shown). In some examples, user devices 106 can be capable of short-range communication using features including, but not limited to, Bluetooth and/or WiFi transceivers.

In some examples, a web site is provided as one or more resources 104 associated with a domain name and hosted by one or more servers. An example web site is a collection of web pages formatted in hypertext markup language (HTML) that can contain text, images, multimedia content, and programming elements, e.g., scripts. Each web site is maintained by a publisher, e.g., an entity that manages and/or owns the web site.

In some examples, a resource 104 is data provided over the network 102 and that is associated with a resource address, e.g., a uniform resource locator (URL). Resources 104 that can be provided can include HTML pages, word processing documents, and portable document format (PDF) documents, images, video, and feed sources, to name just a few. The resources 104 can include content, e.g., words, phrases, images and sounds and may include embedded information, e.g., meta information and hyperlinks, and/or embedded instructions, e.g., scripts.

In some examples, and to facilitate searching of resources 104, the search system 120 identifies the resources 104 by crawling and indexing the resources 104 provided on web sites, for example. Data about the resources 104 can be indexed based on the resource to which the data corresponds. The indexed and, optionally, cached copies of the resources 104 are stored in a search index 122.

In some examples, the user devices 106 submit search queries 109 to the search system 120. In response, the search system 120 accesses the search index 122 to identify resources 104 that are relevant to, e.g., have at least a minimum specified relevance score for, the search query 109. The search system 120 identifies relevant resources 104, generates search results 111 that identify the resources 104, and returns the search results 111 to the user devices 106. In some examples, a search results page 105 is data generated by the search system 120 that identifies one or more resources 104 that are responsive to a particular search query, and includes respective links to the resources 104. An example search results page 105 can include search results represented as a web page title, a snippet of text or a portion of an image extracted from the web page, and the URL of the web page.

Data for the search queries 109 submitted during user sessions are stored in a data store, such as the historical data store 124. For example, the search system 110 can store received search queries in the historical data store 124.

Selection data specifying actions taken in response to search results provided in response to each search query 109 are also stored in the historical data store 124, for example, by the search system 120. These actions can include whether a search result was selected, e.g., clicked or hovered over with a pointer. The selection data can also include, for each selection of a search result, data identifying the search query 109 for which the search result was provided.

In accordance with implementations of the present disclosure, the example environment 100 also includes a connection system 130 and a data store 134. In some examples, the connection system 130 interacts with the search system 120 to connect users based on search queries submitted to the search system 120. In some examples, the connection system 130 can process search queries in view of data stored in the data store 132 and/or historical data from the data store 124 to identify searching users that have submitted corresponding search queries. In some examples, a corresponding search query can include a search query that is the same as, that is similar to, that is a synonym of, that is semantically equivalent to, and/or that is associated with the same or similar topics as a subject query, e.g., the search query submitted by the searching user.

In some examples, corresponding search queries can be determined based on an intent underlying the search query. For example, a first example search query [who are the 2012 presidential candidates] can reflect an intent for a definitive, concrete example. On the other hand, a second example search query [who will win the 2012 presidential election] can reflect an intent for objective opinions, e.g., if submitted before the 2012 presidential election. In these examples, the second example search query can reflect an intent to engage in opinion and discussion regarding the subject topic.

In some examples, searching users that have submitted corresponding search queries are identified based on timeliness of the submission of the corresponding search queries relative to the submitted search query, e.g., concurrently, contemporaneously. For example, the connection system 130 can access historical data from the data store 124 to determine one or more searching users that have submitted queries that are determined to correspond to a received search query. As another example, the connection system 130 can access data provided in the data store 132 to determine connections between searching users. In some examples, users can be connected, e.g., contacts of one another, through one or more computer-implemented services. Example computer-implemented services can include an electronic mail service, a chat service, a video conferencing service, a social networking service, a document sharing service, a video sharing service, an image sharing service, and the like. In some examples, the connection system 130 provides connection data that can be provided in a connection interface 134 displayed with the search results 111. In some examples, the connection interface 134 enables searching users to connect with one another, as discussed in further detail herein.

In some examples, searching users can be connected based on social graphs of the searching users. In some examples, social graph data can be provided in the data store 132. In some examples, a social graph can refer to a single social graph or multiple interconnected social graphs. Distinct social graphs can be generated for different types of connections a user has. For example, a user can be connected with chat contacts in one social graph, email contacts in a second social graph, and connections (or contacts) from a particular social networking service in a third social graph. Each social graph can include edges to additional individuals or entities at higher degrees of separation from the user. These contacts can in turn have additional contacts at another degree of separation from the user. Similarly, a user's connection to someone in a particular social network can then be used to identify additional connections based on that person's connections. The distinct social graphs can include edges connecting one or more social graph to one or more other social graphs. Types of connections and social graphs can include other users in which the user is in direct contact, e.g., user mail or chat contact, direct contacts on social sites and users in which the user is in indirect contact, e.g., friends of friends, connections of users that have a direct connection to the user. In some implementations, the social graph includes content generated by individuals, e.g., blog posts, reviews, as connections to the user. The social graph can include connections within a single network or across multiple networks (separable or integrated). Public social graph relationships can also be considered. In some examples, public relationships can be established through public profiles and/or public social networking services.

Implementations of the present disclosure are generally directed to connecting users based on queries submitted to a search system, e.g., the search system 120 of FIG. 1. More particularly, implementations of the present disclosure include displaying, to a searching user that has submitted a search query, information about other searches being contemporaneously performed by other searching users based on the search query submitted by the searching user. In some examples, such information is displayed on a search results page that also includes search results that are responsive to the submitted query. In some examples, by displaying information about other searches being contemporaneously performed by other searching users based on the search query submitted by the searching user, real-time affirmation is provided to the searching user about the relevance and/or popularity of their interests. In some examples, the information includes other search queries that can have a commonality to the submitted search query, e.g., are determined to be corresponding search queries. Consequently, by displaying information about other searches being contemporaneously performed by other searching users based on the search query submitted by the searching user, extension of an exploratory search session can be encouraged.

In some examples, a connection interface can be displayed within a search results page, and can include the information. For example, if the searching user submits the search query [olympic swimming], the connection interface can display information indicating the number of users who have issued the same query over a pre-defined period of time, e.g., over the past hour. In some examples, if the searching user is not logged into the search system, the displayed information includes no user-specific information. In some examples, if the searching user is logged into the search system, user-specific information can be displayed, e.g., how many of the user's contacts within a computer-implemented social networking service have submitted the search query. For example, because the searching user is logged into the searching service, data associated with the searching user, e.g., a social graph, can be accessed to enhance the information provided in the connection interface with user-specific information. In some examples, location information can be used to enhance the information displayed in the connection interface. For example, if the searching user submitted the search query while at or near a particular location, e.g., Mountain View, Calif., information provided in the connection interface can indicate a number of other users that have also submitted the search query while at or near the same location.

In some implementations, search queries can be normalized to a language. An example language can include English, such that search queries submitted in non-English languages can be normalized to English. In some examples, the language of a search query can be determined. In some examples, if it is determined that the language is non-English, the search query can be translated into English. In this manner, the number of users that have issued the same or similar query over a pre-defined period of time can account for queries submitted in multiple languages.

In some implementations, similar search queries can be displayed to the searching user. In some examples, similar search queries can include search queries that are syntactically and/or semantically similar to the submitted search query and that were submitted within the pre-defined period of time, e.g., over the past hour. For example, the searching user can submit the search query [olympic swimming], and information provided in the connection interface can indicate a number of other users that searched for [100 m freestyle olympics], [london swimming medal ceremony] and/or [olympic swimming champions].

In some implementations, the submitted search query can be provided to a service, e.g., a synonym identifier service, that can provide one or more synonyms that can be associated with the search query. In some examples, for each synonym, search logs, e.g., provided in the historical data store 124 of FIG. 1, can be reviewed to determine a number of users that have submitted the particular synonym as a search query. In some implementations, the submitted search query can be provided to a service, e.g., a related-search service, that can provide one or more search queries that can be associated with the search query. For example, it can be determined that users that search for [olympic swimming] often also search for [100 m freestyle olympics] and/or [olympic swimming champions]. Consequently, [100 m freestyle olympics] and/or [olympic swimming champions] can be provided as related-search queries, e.g., from the related-search service. In some examples, for each related-search query, search logs can be reviewed to determine a number of users that have submitted the particular related-search query as a search query.

In some examples, search queries can be associated based on an underlying intent and/or topical interest. In some examples, an intent service, e.g., provided as a computer-executable program, can process search queries to determine an underlying intent of a user, e.g., retrieve a definitive answer or digest opinion/discussion on a topic. In some examples, an intent can indicate that the searching user is likely to engage in an online discussion regarding the topic.

In some examples, an interest service, e.g., provided as a computer-executable program, can process the search queries to associate search queries with one or more topical interests. In some examples, search queries can be syntactically different, but can correspond to the same or similar interest. For example, the search query [sports cars] and the search query [corvette] can be submitted by respective searching users. Both search queries, although syntactically different, can be associated with the same topical interest, e.g., sports cars. In some examples, a search query can be too ambiguous to identify a topical interest with a sufficiently high confidence. In some examples, if a topical interest cannot be determined from the search query, additional information can be accessed.

In some examples, additional information can include content of one or more documents visited from a search results page provided based on the search query, and/or interaction information based on search results displayed in the search results page. Example interaction information can include a length of time that the searching user views a document underlying a particular search result. For example, a user can select a search result, e.g., click on, from search results page. In response, the user can be directed to a web site represented by the search result. The user can view the web site, and can return to the search results page. In some examples, a time between the user selecting the search result and the user returning to the search results page can be provided as interaction information. In some examples, a relatively short time can indicate that the web site was of less interest to the user, and a relatively long time can indicate that the web site was of more interest to the user. In some examples, the web page can be associated with one or more topical interests, which can be imputed to the search query. For example, if the length of time that the user spends on a web page before returning to the search results page exceeds a threshold time, one or more topical interests associated with the web page can be associated with the search query.

In some implementations, a timeliness of previously submitted queries relative to the query submitted by the searching user can be determined. As noted above, timeliness can include search queries that had been submitted over a pre-defined time period, e.g., last hour. In some examples, timeliness is determined relative to a time at which the query from the searching user is received. As one example, the query can be received at a time t₀, and the pre-defined time period can be measured backward in time from t₀. For example, and if the pre-defined time period is one hour, previously submitted queries can include queries submitted within a time period defined between t₀ and t₁, where t₁ is one hour earlier than t₀.

In some implementations, timeliness can be dynamic and/or can be specific to one or more entities underlying the submitted query. In some examples, an entity can be indicative of a short-term interest. For example, search queries related to an on-going event, e.g., a sporting event, a concert, can be associated with a timeliness that lasts until the end of the event, or shortly after the event. In some examples, an entity can be indicative of a medium-term interest. For example, search queries related to topics, e.g., the U.S. presidential election, can be associated with a timeliness that lasts from months before an event, e.g., an election, to weeks or months after the event. In some examples, an entity can be indicative of a long-term interest. For example, the search queries directed to a general interest, e.g., interior design, scuba diving lessons, can be associated with a longer-term timeliness. In some examples, an interest service, e.g., a computer-executable program, can associate a search query to one or more interests. In some examples, a timeliness service can associate a search query to a timeliness. In some examples, the timeliness service, e.g., a computer-implemented program, can determine a timeliness based on interest data provided from the interest service.

In some examples, a threshold timeliness can be provided and can indicate a time period. In some examples, the threshold timeliness can be determined based on an interest interval, e.g., long-term interest, short-term interest, associated with the searching query In some examples, a time at which the search query was received is compared to a time at which a previous query was received to provide a timeliness of the previous query. In some examples, it is determined whether the timeliness is below the threshold timeliness. In some examples, if the timeliness is below the threshold timeliness, the search query is deemed to be timely with respect to the previous query. Consequently, a user that had submitted the previous query and the searching user that had submitted the search query can be candidates for an online discussion.

Accordingly, and in some implementations, received search queries can be associated with one or more topical interests, and each topical interest can be associated with a respective timeliness.

Implementations of the present disclosure further enable the searching user to connect with other users, e.g., through the connection interface, based on the submitted search query. In some examples, a connection interface displays information regarding a number of users searching for the same or similar search query, and can invite a search user to start an online discussion and/or join an ongoing online discussion. In some examples, online discussion can be facilitated using one or more computer-implemented services, e.g., a question and answer (Q&A) forum, a chat service, a video conferencing service, and/or an electronic mail service. In some examples, the connection interface can include a user-selectable link. In response to user-interaction with the link, e.g., a user click on the link, an online discussion can be instantiated. In some examples, a user instantiating an online discussion can select a type of interaction, e.g., chat messaging, Q&A forum, video conferencing, voice conferencing.

In some implementations, online discussions can be based on user data associated with users. In some examples, users of a search service, e.g., provided by the search system 120 of FIG. 1, can each be associated with an engagement category that reflects user engagement within one or more computer-implemented services. In some examples, each user can be associated with a respective engagement category. In some examples, an engagement categorization service can process user data to categorize engagement of users. In some examples, a user engagement score can be determined based on user interactions within one or more computer-implemented services. In some examples, example user interactions can include user activity in a chat service, user activity in a social networking service, and/or user activity in a Q&A forum service. For example, a first user that often uses the chat service and that frequently interacts within the social networking service, e.g., generates, comments on, endorses and/or re-shares posts in a social networking service, can be assigned a first user engagement score, and a second user that rarely uses the chat service and that rarely interacts within the social networking service, can be assigned a second user engagement score that is less than the first user engagement score.

In some examples, a user engagement score can be determined based on user interactions within online discussions. For example, a user that often starts or joins online discussions in accordance with implementations of the present disclosure can have a higher user engagement score than users that rarely start or join online discussions when invited to.

In some examples, user engagement scores can be compared to one or more threshold user engagement scores to categorize users, e.g., as a high engagement user, a medium engagement user and a low engagement user. Continuing with the example above, it can be determined that the first user engagement score exceeds a first threshold score. Consequently, the first user can be categorized as a high engagement user. Further, it can be determined that the second user engagement score is below a second threshold score. Consequently, the second user can be categorized as a low engagement user. In some examples, the first threshold score and the second threshold score are the same. In some examples, the first threshold score is greater than the second threshold score. In some examples, data reflecting engagement categories can be provided from the data store 132 of FIG. 1.

In some implementations, an online discussion can be instantiated and can include one or more users. For example, a user can be invited to start an online discussion and one or more other users can concurrently, or subsequently join the online discussion. In some examples, a user can be invited to either start or join an online discussion based on an engagement category associated with the user. For example, a user that is a high engagement user can be invited to start an online discussion, while a user that is a low engagement user can be invited to join an online discussion.

In some implementations, a number of users that could take part in an online discussion can exceed a threshold number of users. Consequently, a plurality of online discussions can be provided. That is, for example, a plurality of sub-groups of users can be provided, each sub-group having an associated online discussion. In some examples, the threshold number of users can reflect a number of users, above which discussions are deemed to be unproductive and/or inefficient, e.g., too many users communicating. In some examples, the size of a group contributing to an online discussion can be limited to minimize noise and to optimize engagement.

In some implementations, the threshold number of users can be determined based on user input. For example, a user that instantiates an online discussion can indicate a maximum number of users that can take part in the online discussion. In some examples, the threshold number of users can be determined based on capabilities of a computer-implemented service that is to be user to facilitate the online discussion. For example, a chat service can provide a group chat supporting up to X users, while a video conferencing service can provide a group video conference supporting up to Y users. In some examples, the threshold number of users can be determined based on a machine learning process in view of engagement observed in various group types and/or sizes. For example, it can be observed that group chats including a number of users greater than X users are associated with limited user engagement, e.g., not all, or few users actually contribute to the online discussion, and/or last for short durations, e.g., last for less than a threshold time. Consequently, the threshold number of users for online discussions using group chat is set equal to X users. As another example, it can be observed that video conferences including a number of users greater than Y users are associated with limited user engagement, e.g., not all, or few users actually contribute to the online discussion, and/or last for short durations, e.g., last for less than a threshold time. Consequently, the threshold number of users for online discussions using video conferencing is set equal to Y users. In some examples, the value for the threshold number of users can be dynamic, e.g., can vary based on observed engagement of various group types and/or sizes.

In some implementations, it can be determined that online discussions are to be facilitated using a plurality of groups. In some examples, users can be assigned to specific groups based on similarities between users. In some examples, users can be assigned to groups based on demographics, geographical location, connections within computer-implemented services and/or related interests. For example, it can be determined that one or more users are contacts of one another, and/or are contacts-of-contacts of one another, within a computer-implemented service, e.g., a social networking service. Consequently, the one or more users can be assigned to the same group.

In some implementations, users can be assigned to a group based on location. For example, it can be determined that one or more users are at or near the same location, e.g., Mountain View, Calif. Consequently, the one or more users can be assigned to the same group.

In some implementations, users can be assigned to a group based on topic and location. For example, a topic might be relevant to users located in a particular region, while the topic might not be relevant to users in another region. For example, an online discussion can be associated with the price of milk as the topic. Because such a topic can greatly vary from region-to-region, e.g., between countries, users within the same region can be assigned to a group.

In some implementations, each group can include at least one user based on a user engagement category associated with the user. For example, it can be determined that particular users often engage in online discussions from a search results page, and have relatively high levels of interaction during such online discussions, e.g., high engagement users. In some examples, at least one high engagement user can be assigned to each group to promote engagement and interaction within each group.

In some implementations, each group can include a cross-section of user engagement categories. For example, a particular group can be assigned an example cross-section that includes A % high engagement users, B % medium engagement users and C % low engagement users. If, for example, a medium engagement user is to be assigned to a group, the medium engagement user can be assigned to the particular group, if the percentage of medium engagement users is less than B %. If the percentage of medium engagement users is not less than B %, the medium engagement user can be assigned to another group.

In some examples, users can be invited to join particular groups in an effort to maintain the cross-section associated with the group. For example, if a medium engagement user leaves an online discussion and, consequently, the percentage of medium engagement users falls below B %, another medium engagement user can be invited to join the group.

In some examples, cross-sections can be determined based on a learning process, e.g., machine learning. For example, activity within online discussions can be reviewed to determine the appropriate or optimal cross-section of user engagement categories that reflect successful online discussions. In some examples, an online discussion can be determined to be successful if the online discussion lasts longer than a threshold period of time and/or a number of interactions between users during the online discussion exceeds a threshold number of interactions. In some examples, cross-sections can vary between regions, e.g., country-to-country. For example, in a first region, a first cross-section can provide a successful online discussion, and, in a second region, a second cross-section can provide a successful online discussion, the first cross-section being different from the second cross-section.

In some implementations, users can be invited to particular groups based on viewpoints associated with the users. In some examples, a user can be associated with a viewpoint category. In some examples, a user's viewpoint can be determined based on an explicit user setting, e.g., from a user-defined profile. In some examples, a user's viewpoint can be determined based on implicit user information, e.g., previous searches conducted by the user. In some examples, data reflecting viewpoint categories can be provided from the data store 132 of FIG. 1. In some examples, users having the same or similar viewpoints can be invited to the same group. In this manner, an online discussion can be facilitated between like-minded users. In some examples, users having disparate viewpoints can be invited to the same group. In this manner, an online discussion can be facilitated to engage users that might normally not interact with one another.

In some implementations, each group can include an associated moderator. In some example, the at least one high engagement user can be assigned the role of moderator within the online discussion. In some examples, the moderator can be provided with capabilities for moderating the online discussion that other users within the group do not have. For example, a moderator can remove users from the group and/or mute users from the online discussion, e.g., users that are being abusive to other users during the online discussion.

In some implementations, gamification features can be provided. In some examples, users can be given virtual rewards, reviews and/or ratings based on their participation in online discussions. In some examples, rewards can indicate a user's level of participation in online discussions. For example, if the user participates in at least M online discussions, a first reward level and be provided to the user, and if the user participates in at least N online discussions, a second reward level can be provided to the user, where N is greater than M. In some examples, users that participate in online discussions can rate and/or provide reviews of other users that have participated in the same online discussions. In some examples, a user can be selected as a moderator based on rewards, ratings and/or reviews. For example, a user having a rating that exceeds a threshold rating can be determined to be qualified to serve as a moderator for online discussions.

In some implementations, a group can be created by a user. For example, the user can be invited to start an online discussion. In response to the user starting the online discussion, the user can select other users to participate in the discussion. In some examples, the user can invite other users from users that have been identified as co-searching the same or similar query as submitted by the user. In some examples, the user can invite other users even though they have not been identified as co-searching the same or similar query as the user, e.g., inviting one or more electronic mail contacts and/or social networking contacts.

In some implementations, users can participate in an online discussion in either an authenticated manner, e.g., the user is signed into the search service, or an unauthenticated manner, e.g., the user is not signed into the search service. In some examples, if the user is participating as an authenticated user, an identifier associated with the user can be provided within the online discussion. In some examples, if the user is participating as an authenticated user, the user can select to remain anonymous within the online discussion. In some examples, a user can choose to partake in the online discussion under a created persona.

In some implementations, users can adjust privacy setting during an online discussion. In some examples, a menu can be provide, through which a user can select privacy settings before and/or during the online discussion that the user is participating in. In some examples, the user can select to remain anonymous to all other users. In some examples, the user can select to reveal their identity to one or more user-selected other users. For example, the user can select to reveal their identity to a first set of one or more other users, while remaining anonymous to a second set of one or more other users. In some examples, the user's identity can be revealed to one or more other users that are also contacts of the user in one or more computer-implemented services. For example, the user can remain anonymous to most other users participating in the online discussion, but the user's identity can be revealed to another user that is a contact of the user in a social networking service.

In some implementations, features of the online discussion can be persisted, published and/or shared. In some examples, features of the online discussion can include the time, date and/or type, e.g., chat, video, of the online discussion, the number of participants that took part in the online discussion, and/or the submitted search query/queries that prompted the online discussion. In some examples, a user that took part in the online discussion can share features of the online discussion using one or more computer-implemented services, e.g., in a post to a social networking service. In some examples, a user that left the online discussion early, e.g., before conclusion of the online discussion, can be provided data that details the remainder of the online discussion. For example, the user can receive a notification, e.g., an electronic mail, that includes a link to the data. In some examples, the data can include text data, video data, and/or image data that depict the online discussion, e.g., interactions between users during the online discussion.

In some implementations, a non-searching user can be made aware of an online discussion and can be invited to join the online discussion. For example, and as discussed above, an online discussion can be initiated based on received search queries and can include users that had submitted corresponding search queries to a search service, e.g., provided by the search system 120 of FIG. 1. As also discussed above, an online discussion can reflect a particular topic or topics, e.g., sports cars. In some examples, one or more users can be determined to be knowledgeable, or experts in a particular topic. In some examples, data reflecting expertise of particular users with respect to topics can be provided from the data store 132 of FIG. 1. In some implementations, if an online discussion is associated with a topic that another user is determined to be an expert in, or knowledgeable of, e.g., an expert user, the expert user can be invited to join the discussion. In some examples, the expert user can include a non-searching user, e.g., the expert user did not submit a search query prompting their invitation to join the discussion. Instead, the expert user is invited to join the online discussion based on their expertise in the particular topic(s).

In some examples, a notification, e.g., an electronic mail, a chat message, including a link to the online discussion can be provided to the expert user. In some examples, the notification can be triggered based on activity during the online discussion. For example, a number of interactions and/or a rate of interactions between users participating in an online discussion can be determined. In some examples, an online discussion can be categorized, e.g., in one of a plurality of activity categories, based on the number of interactions and/or the rate of interactions. For example, if the number of interactions and/or the rate of interactions exceed respective thresholds, the online discussion can be categorized as high activity, e.g., hot. Other example activity categories can include low activity and moderate activity. In some examples, a notification is provided to an expert user based on the category of the online discussion. For example, if the particular online discussion is categorized as something other than high activity, a notification is not sent to an expert user. However, if the online discussion is categorized as high activity, the notification is sent to the expert user.

In some implementations, an activity category of an ongoing discussion can be indicated to a user that is invited to join the online discussion. For example, and as discussed above, the connection interface can display information regarding a number of users searching based on corresponding search queries, and can invite a search user to join an ongoing online discussion. In some examples, an invitation provided in the connection interface can include an indication of an activity category. In some examples, indications can include explicit indications, e.g., the invite can include the category of the online discussion. In some examples indications can include implicit indications. For example, text of the invitation is color-coded based on activity category, e.g., high activity includes red text, moderate activity includes orange text, low activity includes blue text. In some examples, indications can include explicit and implicit indications.

In some implementations, connection interfaces and/or invitations within connection interfaces are provided for a variable percentage of searching users. In some examples, an initial percentage can be provided and can be increased or decreased based user engagement triggered or not triggered. For example, a connection interface can be displayed to Q % of searching users that submit corresponding search queries, where Q % is less than 100%. In some examples, if many of the invited searching users participate in online discussions, e.g., start or join online discussions, it can be determined that the particular topic(s) underlying the online discussion are topics that users are interested in engaging on. Consequently, the value of Q % can be increased. In some examples, the value of Q % can be incrementally increased, and can eventually be increased to 100%, such that invitations are always provided in connection interfaces for the particular topic(s). In some examples, if few of the invited searching users participate in online discussions, e.g., start or join online discussions, it can be determined that the particular topic(s) underlying the online discussion are not topics that users are interested in engaging on. Consequently, the value of Q % can be decreased. In some examples, the value of Q % can be decreased to 0%, such that no invitations are provided in connection interfaces for the particular topic(s).

In some examples, the value of Q % can be increased from 0%, to revive inclusion of invitations in connection interfaces for the particular topic(s). For example, it can be determined that there is a spike in submission of search queries that are associated with the particular topic(s), e.g., indicating a possible resurgence in interest in the particular topic(s). In response to the spike, the value of Q % can be increased from 0%, e.g., set back to the initial percentage. As another example, it can be determined that the particular topic(s) are increasingly associated with digital content distributed using one or more computer-implemented services, e.g., a news service, a social networking service, indicating a possible resurgence in interest in the particular topic(s). In response, the value of Q % can be increased from 0%, e.g., set back to the initial percentage.

In some implementations, a discussion interface can be displayed in response to user selection of an invitation to participate in an online discussion, e.g., start or join an online discussion. In some examples, the discussion interface is based on a particular communication channel associated with the online discussion. For example, if the online discussion is to be conducted as a chat session, a chat interface is provided, as a video conferencing session, a video conferencing interface is provided, as a Q&A forum, a Q&A interface is provided.

In accordance with implementations of the present disclosure, online discussions can be initiated directly from the search results page and can be provided using a discussion interface that is displayed within the search results page. In some examples, the discussion interface is provided as an overlay to the search results page. In some examples, the discussion interface has the appearance of hovering over the search results page. In some examples, the discussion interface can be embedded within the search results page.

In some implementations, and in response to the searching user selecting to participate in an online discussion, computer program code, e.g., Javascript, is processed to display the discussion interface. In some examples, the discussion interface is provided as a widget that is loaded based on processing of the computer program code. In some examples, the widget is provided as a user interface element (e.g., a button or dropdown menu) that is responsive to user input. In some examples, user interaction with a widget (e.g., a click on a button widget) can result in a change in the widget's appearance and/or the display of a new user interface element.

In some implementations, users participating in the online discussion can navigate away from the search results page, while still participating in the online discussion. In this manner, users can review and discuss documents, e.g., web pages, underlying the search results displayed in the search results page during the online discussion. In some examples, the discussion interface can be provided in a first frame of a web browser window and a document, e.g., the search results page, web page, can be displayed in a second frame of the web browser window.

In some implementations, online discussion can be initiated from a displayed document. In some examples, and as discussed above, the document can include a search results page provided by a search service, e.g., provided by the search system 120 of FIG. 1. In some examples, a document can include a web page provided by a publishing entity. In some examples, the web page can include underlying computer-executable code, e.g., embedded code, that monitors user arrivals to the web page, e.g., from a search results page. In some examples, the computer-executable code can trigger display of a connection interface to invite users to participate in an online discussion, as discussed in detail herein.

FIG. 2 depicts a screen shot of an example search interface 200 in which a search results page 202 is provided. In the depicted example, example search results 211a-211d are provided in the search results page 202. The search interface 200 can be presented at a user device 106 and includes a query entry field 205 in which a user can enter a search query 209. The search interface 200 also includes a query initiation element 207 with which the search query 209 can be submitted to the search system 120. For example, in response to user interaction with the search initiation element 207, the user device 106 can submit the search query 209 to the search system 120.

In the example of FIG. 2, a connection interface 240 is provided. In some examples, the connection interface 240 is displayed based on determining that other users are searching based on corresponding search queries, e.g., search queries the same as or similar to [Canada]. Consequently, the connection interface 242 includes an indication 242 of the number of other users that have submitted a corresponding search query. In the depicted example, the connection interface 240 includes an invitation 246 to start an online discussion. In some examples, the user can select the invitation 246, e.g., click on the text “here,” to instantiate the online discussion, in accordance with implementations discussed herein.

FIGS. 3A-3D depict example connection interfaces that can be displayed in search results pages.

FIG. 3A depicts an example connection interface 300. In some examples, the connection interface 300 is displayed in response to determining that other users are searching based on corresponding search queries, e.g., search queries the same as or similar to [Canada]. Consequently, the connection interface 300 includes an indication 302 of the number of other users that have submitted a corresponding search query. In the depicted example, the connection interface 300 includes an invitation 304 to join an ongoing online discussion. In some examples, the user can select the invitation 306, e.g., click on the text “here,” to join the online discussion.

FIG. 3B depicts an example connection interface 310. In some examples, the connection interface 310 is displayed in response to determining that other users are searching based on corresponding search queries, e.g., search queries the same as or similar to [Canada]. Consequently, the connection interface 310 includes an indication 312 of the number of other users that have submitted a corresponding search query. In the depicted example, the connection interface 310 includes a location indication 314 that indicates the number of users that are located at or within a particular location, e.g., Mountain View, Calif. For example, if the searching user submitted the search query while at or near a particular location, e.g., Mountain View, Calif., information provided in the location indication 314 can indicate a number of other users that have also submitted a corresponding search query while at or near the same location.

FIG. 3C depicts an example connection interface 320. In some examples, the connection interface 320 is displayed in response to determining that other users are searching based on corresponding search queries, e.g., search queries the same as or similar to [Canada]. Consequently, the connection interface 320 includes an indication 322 of the number of other users that have submitted a corresponding search query. In some examples, the indication 322 can indicate a search query that is the same as or similar to the search query submitted by the searching user. In the depicted example, the connection interface 320 includes indications 324, 326. In some examples, the indications 324, 326 indicate respective search queries that are determined to correspond to the received search query, e.g., [Canada]. In some examples, search queries identified in the respective indications 324, 326 can be user-selectable and, in response to user selection, can trigger a search based on a selected search query. For example, if the searching users selects the corresponding search query [hockey in Canada], a search can be conducted, and search results responsive to the corresponding search query can be displayed in a search results page. In this manner, a search can be initiated from the connection interface 320.

FIG. 3D depicts an example connection interface 330. In some examples, the connection interface 330 is displayed in response to determining that other users are searching based on corresponding search queries, e.g., search queries the same as or similar to [Canada]. Consequently, the connection interface 330 includes an indication 332 of the number of other users that have submitted a corresponding search query. In the depicted example, the connection interface 330 includes indications 334, 336 indicating respective contacts of the searching user. In some examples, the contacts can include contacts of the user within one or more computer-implemented services, e.g., a social networking service. In some examples, contact identifiers provided in the respective indications 334, 336 can be user-selectable and, in response to user selection, can trigger a communication channel, e.g., an electronic mail, with the selected contact, and/or display of a profile page associated with the selected contact.

It is appreciated that the connection interfaces of FIGS. 2 and 3A-3D include example connections interfaces. Further, it is contemplated that the indications and invitations, such as those depicted in FIGS. 2 and 3A-3D, can be provided in various combinations within a connection interface. For example, an example connection interface can include indications 302, 314, 324, 326, 334, and/or 336, as appropriate, and/or invitations 246 and/or 304, as appropriate.

FIG. 4 is a flow chart of an example process 400 that can be executed in accordance with implementations of the present disclosure. The example process 400 can be implemented, for example, by the search system 120 in conjunction with the connection system 130. In some examples, the example process 400 can be provided by one or more computer-executable programs executed using one or more computing devices.

A query is received (402). For example, and with reference to FIG. 1, a search query 109 can be received by the search system 120 from a user device 106. One or more other users are attempted to be determined based on the query (404). In some examples, it is determined whether one or more other users have submitted queries that correspond to the received query, as discussed above. In some examples, it is determined whether submitted queries are timely with respect to the received query, as discussed above. It is determined whether one or more other users have been determined based on the received query (406). If one or more other users have not been determined, the search results are provided to the searching user (408), e.g., in a search results page.

If one or more other users have been determined, it can be determined whether the user that submitted the query is authenticated (410). If it is determined that the user is not authenticated, the search results and a connection interface are provided to the searching user (412), e.g., in a search results page. In some examples, the connection interface can include an invitation to participate in an online discussion, as discussed herein. If it is determined that the user is authenticated, it can be determined whether there is an intersection between the one or more other users and contacts of the user in one or more computer-implemented services (414). In some examples, if there is not intersection, the search results and a connection interface are provided to the searching user (412), e.g., in a search results page. In some examples, the connection interface can include an invitation to participate in an online discussion, as discussed herein. In some examples, if there is an intersection, the search results and a connection interface indicating contacts of the user are provided to the searching user (416), e.g., in a search results page. In some examples, the connection interface can include an invitation to participate in an online discussion, as discussed herein.

Implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer can include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any implementation of the present disclosure or of what may be claimed, but rather as descriptions of features specific to example implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
receiving, by the data processing apparatus, a search query from a searching user;
defining, by the processing apparatus, a set of users based on the query, the set of users being a sub-set of a super-set of users and comprising one or more users that have submitted queries that are determined to correspond to the search query;
providing an electronic document comprising instructions that, when executed by a computing device, cause the computing device to display a search results page comprising search results responsive to the search query and a connection interface, the connection interface displaying at least one indication of users of the set of users; and
transmitting, by the data processing apparatus, the electronic document to a computing device associated with the searching user.

2. The method of claim 1, wherein the connection interface displays a user-selectable invitation to participate in an online discussion.

3. The method of claim 2, further comprising providing instructions to display a connection interface to the searching user in response to user input to the invitation, the connection interface providing a communication channel for user participation in the online discussion.

4. The method of claim 2, further comprising assigning the searching user to a discussion group in response to user input to the invitation.

5. The method of claim 4, wherein assigning the searching user to the discussion group is based on an engagement category associated with the searching user.

6. The method of claim 1, further comprising, for each user of the superset of users:
associating a threshold timeliness with a query submitted by a respective user;
comparing a time at which the search query was received to a time at which the query was received to provide a timeliness of the query; and
determining that the timeliness is below the threshold timeliness and, in response, including the respective user in the set of users.

7. The method of claim 1, wherein the threshold timeliness is determined based on an interest interval associated with the searching query.

8. The method of claim 1, wherein a query that corresponds to the search query comprises a query that is at least one of the same as the search query, similar to the search query, is a synonym of the search query, is semantically equivalent to the search query, and that is associated with the same or similar topics as the search query is associated with.

9. The method of claim 1, wherein the at least one indication comprises at least one of a number of users in the set of users, a location of users in the set of users, and at least one user in the set of users that is also a contact of the searching user in one or more computer-implemented services.

10. A system comprising:
a data store for storing data; and
one or more processors configured to interact with the data store, the one or more processors being further configured to perform operations comprising:
receiving a search query from a searching user;
defining a set of users based on the query, the set of users being a sub-set of a super-set of users and comprising one or more users that have submitted queries that are determined to correspond to the search query;
providing an electronic document comprising instructions that, when executed by a computing device, cause the computing device to display a search results page comprising search results responsive to the search query and a connection interface, the connection interface displaying at least one indication of users of the set of users; and
transmitting the electronic document to a computing device associated with the searching user.

11. The system of claim 10, wherein the connection interface displays a user-selectable invitation to participate in an online discussion.

12. The system of claim 11, wherein operations further comprise providing instructions to display a connection interface to the searching user in response to user input to the invitation, the connection interface providing a communication channel for user participation in the online discussion.

13. The system of claim 11, wherein operations further comprise assigning the searching user to a discussion group in response to user input to the invitation.

14. The system of claim 13, wherein assigning the searching user to the discussion group is based on an engagement category associated with the searching user.

15. The system of claim 10, wherein operations further comprise, for each user of the superset of users:
associating a threshold timeliness with a query submitted by a respective user;
comparing a time at which the search query was received to a time at which the query was received to provide a timeliness of the query; and
determining that the timeliness is below the threshold timeliness and, in response, including the respective user in the set of users.

16. The system of claim 10, wherein the threshold timeliness is determined based on an interest interval associated with the searching query.

17. The system of claim 10, wherein a query that corresponds to the search query comprises a query that is at least one of the same as the search query, similar to the search query, is a synonym of the search query, is semantically equivalent to the search query, and that is associated with the same or similar topics as the search query is associated with.

18. The system of claim 10, wherein the at least one indication comprises at least one of a number of users in the set of users, a location of users in the set of users, and at least one user in the set of users that is also a contact of the searching user in one or more computer-implemented services.

19. A computer readable medium storing instructions that, when executed by one or more processors, cause the one or more processors to perform operations comprising:
receiving a search query from a searching user;
defining a set of users based on the query, the set of users being a sub-set of a super-set of users and comprising one or more users that have submitted queries that are determined to correspond to the search query;
providing an electronic document comprising instructions that, when executed by a computing device, cause the computing device to display a search results page comprising search results responsive to the search query and a connection interface, the connection interface displaying at least one indication of users of the set of users; and
transmitting the electronic document to a computing device associated with the searching user.

20. The computer readable medium of claim 19, wherein the connection interface displays a user-selectable invitation to participate in an online discussion.

21. The computer readable medium of claim 20, wherein operations further comprise providing instructions to display a connection interface to the searching user in response to user input to the invitation, the connection interface providing a communication channel for user participation in the online discussion.

22. The computer readable medium of claim 20, wherein operations further comprise assigning the searching user to a discussion group in response to user input to the invitation.

23. The computer readable medium of claim 22, wherein assigning the searching user to the discussion group is based on an engagement category associated with the searching user.

24. The computer readable medium of claim 19, wherein operations further comprise, for each user of the superset of users:
associating a threshold timeliness with a query submitted by a respective user;
comparing a time at which the search query was received to a time at which the query was received to provide a timeliness of the query; and
determining that the timeliness is below the threshold timeliness and, in response, including the respective user in the set of users.

25. The computer readable medium of claim 19, wherein the threshold timeliness is determined based on an interest interval associated with the searching query.

26. The system of claim 19, wherein a query that corresponds to the search query comprises a query that is at least one of the same as the search query, similar to the search query, is a synonym of the search query, is semantically equivalent to the search query, and that is associated with the same or similar topics as the search query is associated with.

27. The system of claim 19, wherein the at least one indication comprises at least one of a number of users in the set of users, a location of users in the set of users, and at least one user in the set of users that is also a contact of the searching user in one or more computer-implemented services.
